(19) United States
(12) Patent Application Publication
(10) Pub. No.: US 2013/0213786 A1
(43) Pub. Date: Aug. 22, 2013

(54) HOUSING AND ELECTRONIC DEVICE USING SAME

(71) Applicant: JIAN-YONG YANG, Shenzhen City (CN)

(72) Inventor: JIAN-YONG YANG, Shenzhen City (CN)

(21) Appl. No.: 13/629,691

(22) Filed: Sep. 28, 2012

(30) Foreign Application Priority Data
Feb. 20, 2012 (CN) 201210037802.0

(51) Int. Cl. H01H 15/02

(52) U.S. Cl. 200/548

(57) ABSTRACT

An electronic device includes a housing, a first positioning component, a second positioning component, a key switch and a key mechanism. The first and second positioning components are arranged in the housing. The key mechanism is movably secured to the housing and includes an actuating component slidably arranged on an inner surface of the housing and capable of triggering the key switch when sliding relative to the inner surface. The first and second positioning components abut opposite sides of the actuating component for preventing the actuating component from shimmying when the actuating component slides relative to the inner surface.

### BACKGROUND

1. Technical Field

The present disclosure relates to electronic devices; and more particularly, to an electronic device having a housing for mounting a key mechanism.

2. Description of Related Art

Electronic devices, such as computers, DVD players and mobile phones, may have at least a key mechanism for receiving users' operations. Typical key mechanism includes an operating component and an actuating component abutting the operating component for triggering a corresponding key switch. The operating component and the actuating component are movably arranged on opposite sides of a housing of the electronic device. When persistent force is applied to the operating component, the actuating component may be damaged.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partial perspective view of an electronic device having a key mechanism.

FIG. 2 is a partially enlarged view of the electronic device of FIG. 1.

FIG. 3 is a partially disassembled view of the electronic device of FIG. 2.

FIG. 4 is a partially assembled view of the electronic device of FIG. 3 in a first state.

FIG. 5 is a partially assembled view of the electronic device of FIG. 4 in a second state.

### DETAILED DESCRIPTION

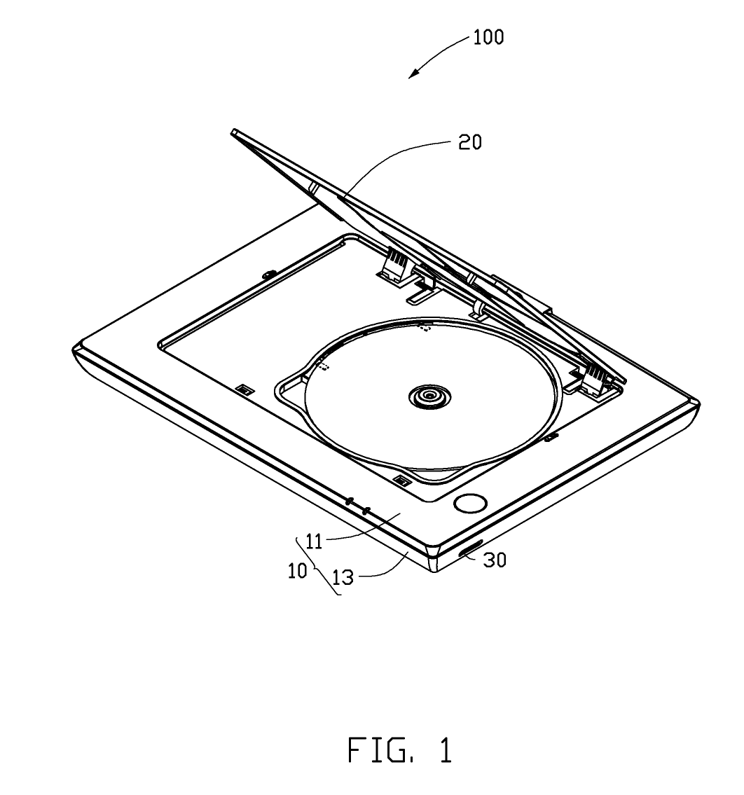

Referring to FIG. 1, an electronic device 100 includes a housing 10, a cover 20, a key mechanism 30 secured to the housing 10. The cover 20 is rotatably coupled to the housing 10, and is capable of being closed and opened with respect to the housing 10 by an external force. The key mechanism 30 is movably arranged on the housing 10 for receiving users' operations. The electronic device 100 may be a computer, DVD player and a mobile phone. In the embodiment, the electronic device 100 is a DVD player.

The housing 10 is substantially rectangular, and includes a top case 11 and a bottom case 13 opposite to the top case 11. The top case 11 engages with the bottom case 13 to define a closed space (not shown), for receiving components of the electronic device 100.

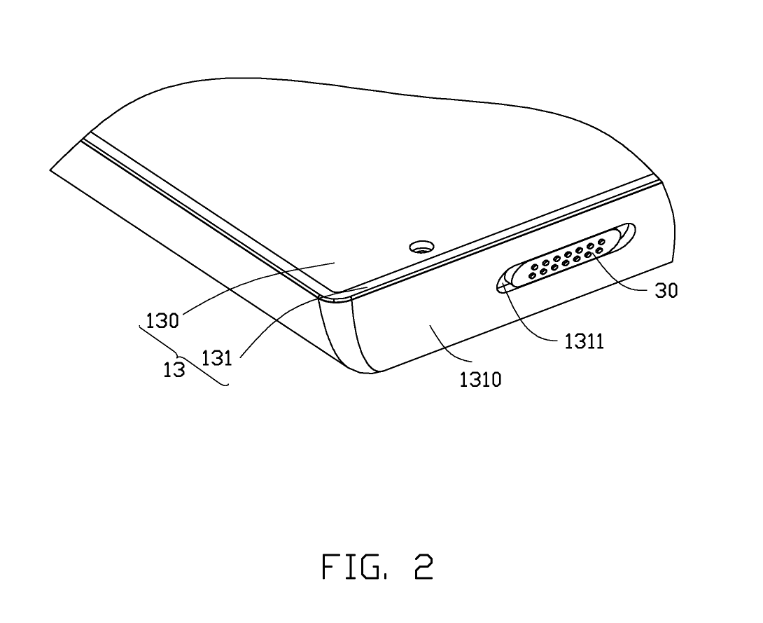

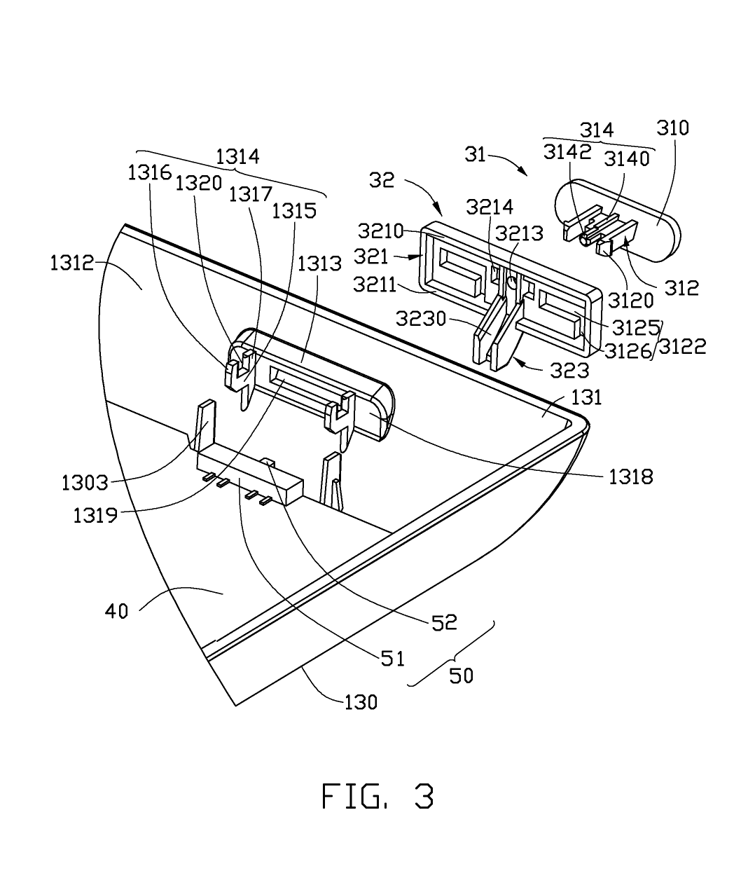

Referring to FIGS. 2 and 3, the bottom case 13 includes a bottom wall 130 and a plurality of sidewalls connecting to the bottom wall 130. The bottom wall 130 includes two first positioning components 1303. The two first positioning components 1303 protrude from the bottom wall 130 and are adjacent to one of the sidewalls (referred herein as the first sidewall 131). An end of each first positioning component 1303 keeps a predetermined gap with the first sidewall 131. In the embodiment, the two first positioning components 1303 are plate-shaped.

The first sidewall 131 slantingly extends from a rim of the bottom wall 130. The first sidewall 131 includes an outer surface 1310 and an inner surface 1312 opposite to the first surface 1310. The outer surface 1310 defines a receiving groove 1311. The receiving groove 1311 extends in a direction parallel to the bottom wall 130.

A mounting base 1313 and two second positioning components 1314 are secured to the inner surface 1312. The mounting base 1313 protrudes from the inner surface 1312 and surrounds the receiving groove 1311. A mounting hole 1319 is defined on the bottom of the receiving groove 1311. The mounting base 1313 includes a mounting surface 1318 opposite to the inner surface 1312. The plane of the mounting surface 1318 is perpendicular to the bottom wall 130.

The two second positioning components 1314 are arranged on the mounting surface 1318 and are arranged at opposite ends of the mounting hole 1319. The two second positioning components 1314 are aligned parallel to the bottom wall 130. Each second positioning component 1314 includes a guiding portion 1315, a resisting portion 1316 and a supporting portion 1317. The supporting portion 1317 is substantially a narrow strip-shaped, and perpendicularly protrudes from the mounting surface 1318. The guiding portion 1315 perpendicularly extends from a surface of the supporting portion 1317 opposite to the inner surface 1312. The resisting portion 1316 perpendicularly extends from an end of the guiding portion 1315 opposite to the supporting portion 1317 and is away from the bottom wall 130. Thus, the supporting portion 1317, the guiding portion 1315 and the resisting portion 1316 cooperatively define an opening 1320.

The electronic device 100 further includes a circuit board 40 and a key switch 50 electrically connected to the circuit board 40. The circuit board 40 is secured to a surface of the bottom wall 130 opposite to the top case 11. The key switch 50 is arranged on a side of the two first positioning components 1303 opposite to the first sidewall 131. The key switch 50 includes a main body 51 and a switch 52. The switch 52 protrudes from a side of the main body 51 and faces the first sidewall 131.

The key mechanism 30 is movably coupled to the first sidewall 131. The key mechanism 30 includes an operating component 31 and an actuating component 32 connected to the operating component 31 for triggering the key switch 50.

The operating component 31 is arranged on the outer surface 1310 of the first sidewall 131. The operating component 31 includes an operating portion 310, two latching portions 312, and a fixing portion 314. The operating portion 310 is received in the receiving groove 1311 and is exposed out of the first sidewall 131. The shape of the operating portion 310 corresponds to the shape of the receiving groove 1313. The length of the operating portion 310 parallel to the bottom wall 130 is shorter than the corresponding length of the receiving groove 1311, for allowing the operating portion 310 to slide along the receiving groove 1311 in a direction parallel to the bottom wall 130.

The two latching portions 312 perpendicularly protrude from the same surface of the operating portion 310 and are spaced apart from each other. An end of each latching portion 312 opposite to the operating portion 310 bents to form a hook portion 3120. The two hook portions 3120 extending in reverse direction. The fixing portion 314 is arranged between the two latching portions 312, and includes a fixing plate 3140 and a fixing post 3142. Opposite ends of the fixing plate 3140 respectively connect with the two latching portions 312. The fixing post 3142 is substantially cross-shaped, and protrudes from an end of the fixing plate 3140 opposite to the operating portion 310.

The actuating component 32 is arranged on the inner surface 1312 of the first sidewall 131. The actuating component 32 includes a body 321 and a driving portion 323. The body 321 is substantially rectangular, and includes a first rim 3210 and a second rim 3211 parallel and opposite to the first rim 3210. The actuating component 32 defines two L-shaped sliding slots 3122, two through holes 3214, and a fixing hole 3213. The two sliding slots 3122 are defined at opposite ends of the body 321, and are spaced from each other. Each sliding slot 3122 includes a first sliding slot 3125 and a second sliding slot 3126. The first sliding slot 3125 extends in a direction parallel to the first rim 3210. The second sliding slot 3126 extends in a direction perpendicular to the first rim 3210 and communicates to the first sliding slot 3125. The two through holes 3214 are defined between the two sliding slots 3122 and are spaced apart from each other. The shape of through holes 3214 correspond to the shape of the corresponding hook portions 3120. The fixing hole 3213 is defined between the two through holes 3214. The shape of the fixing hole 3213 corresponds to the shape of the fixing post 3142.

The driving portion 323 protrudes from the middle portion of the second rim 3211 and is upwardly inclined relative to the body 321. The middle portion of the driving portion 323 defines a latching slot 3230 for engaging with the switch 52.

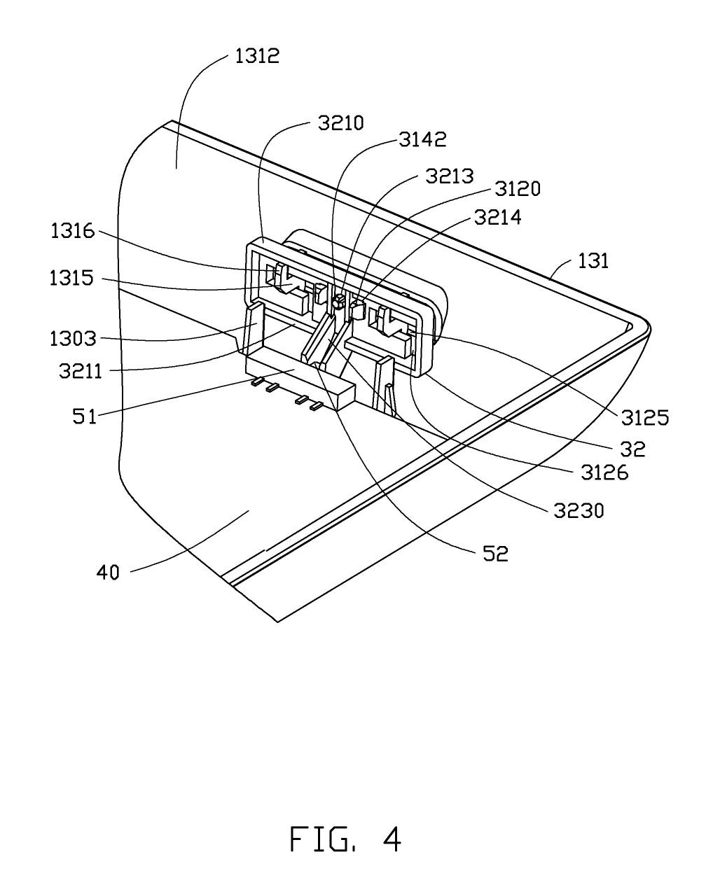

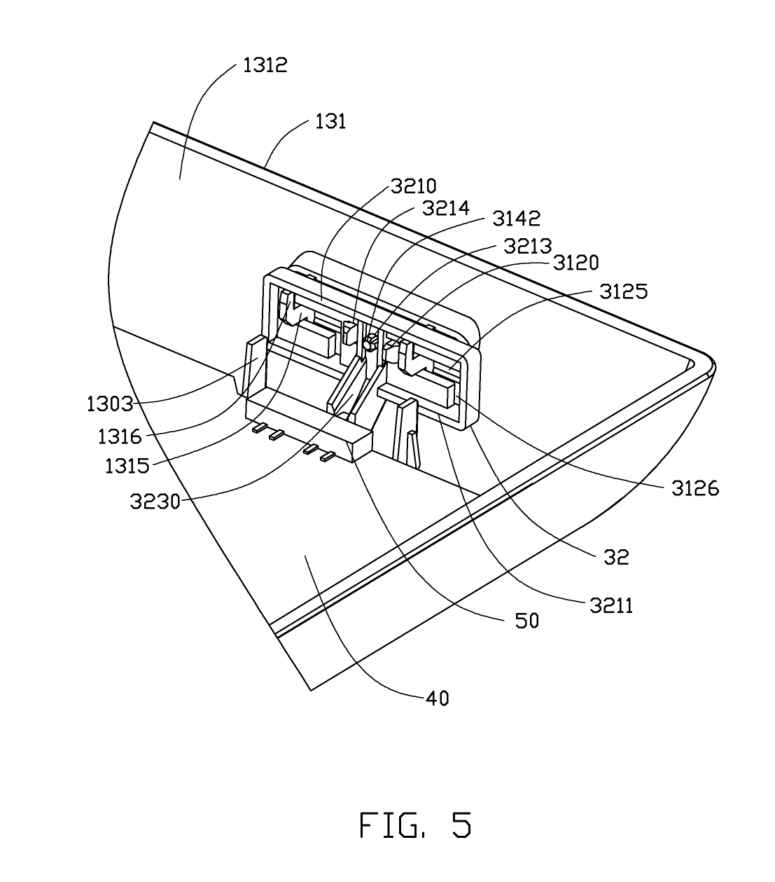

Referring to FIGS. 4 and 5, in assembly, the second rim 3211 resists between the first positioning component 1303 and the inner surface 1312. The two resisting portions 1316 extend through the corresponding second sliding slots 3126 and hook the body 321 with the two guiding portions 1315 received in the corresponding first sliding slots 3125. The first rim 3210 is movably received between the supporting portion 1317 and the resisting portion 1316 via the opening 3120. The switch 52 is latched to the latching slot 3230.

The operating portion 310 is slidably received in the receiving groove 1311. The two latching portions 312 and the fixing portion 314 extend through the mounting hole 1311. The two latching portions 312 are received in the corresponding through holes 3214, with the two hook portions 3120 hooking opposite edges of the corresponding through holes 3214 in reverse direction. The fixing post 3142 is received in the fixing hole 3213.

After assembly, the first rim 3210 is slidably received between the two resisting portions 1316 and the two supporting portions 1317 via the corresponding openings 1320. The second rim 3211 is sandwiched between the two first position components 1303 and the first sidewall 131. Thus, the actuating component 32 is steadily secured to the operating component 31 in a first direction parallel to the bottom wall 130. Furthermore, the two hook portions 3120 hook the body 321, for preventing the operating component 31 from detaching from the first sidewall 131. The two latching portions 312 hook opposite sides of the body 321 in a second direction perpendicular to the first direction, for securing the actuating component 32 to the operating component 31 in the second direction.

In use, the operating component 31 is operated to slide along the 1311 in a direction parallel to the bottom wall 130, and the actuating component 32 is driven by the operating component 31 to slide in a direction parallel to the inner surface 1312. As a result, the driving portion 323 triggers the switch 52 for turning on/off the key switch 50.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a housing;
a first positioning component arranged in the housing;
a second positioning component arranged on an inner surface of the housing and spaced apart from the first positioning component;
a key switch received in the housing; and
a key mechanism movably secured to the housing and corresponding to the key switch, the key mechanism comprising:
an actuating component slidably arranged on the inner surface and capable of triggering the key switch when sliding relative to the inner surface;
wherein the first and second positioning components abut opposite sides of the actuating component for preventing the actuating component from shimmying when the actuating component sliding relative to the inner surface.

2. The electronic device as claimed in claim 1, wherein the key mechanism comprises an operating component, the housing defines a mounting hole; the operating component is slidably received in the mounting hole for driving the actuating component to slide relative to the inner surface.

3. The electronic device as claimed in claim 2, wherein the operating component comprises an operating portion and two latching portions; the operating portion is exposed out of the housing, the two latching portions extend through the mounting hole and couple to the actuating component.

4. The electronic device as claimed in claim 3, wherein the two latching portions comprise two hook portions, the actuating component defines two through holes; the two hook portions are respectively hooked to the through holes in a reverse direction for preventing the operating component from detaching from the actuating component.

5. The electronic device as claimed in claim 4, wherein the operating component comprises a fixing portion, the fixing portion comprises a fixing plate and a fixing post, the actuating component defines a fixing hole; the fixing plate is arranged between the two latching portions, the fixing post is received in the fixing hole.

6. The electronic device as claimed in claim 5, wherein the size of the fixing post is smaller than the fixing plate, the actuating component resists between the two hook portions and the fixing plate.

7. The electronic device as claimed in claim 1, wherein the housing comprises a bottom wall and a first sidewall extending from a rim of the bottom wall; the actuating component comprises a first rim and a second rim opposite to the first rim; the first positioning component extends from the bottom wall and abuts the second rim, the second positioning component protrudes from the first sidewall and abuts the first rim.

8. The electronic device as claimed in claim 1, wherein the second positioning component comprises a supporting portion, a resisting portion, and a guiding portion connected between the supporting portion and the resisting portion; the first rim is received between the supporting portion and the resisting portion.

9. The electronic device as claimed in claim 8, wherein the actuating component defines a sliding slot, the guiding portions is slidably received in the sliding slot.

10. The electronic device as claimed in claim 1, wherein the actuating component comprises a driving portion, the driving portion defines a latching slot for engaging with the key switch.

11. A housing of an electronic device, the electronic device comprises a key mechanism fixed to the housing, the key mechanism comprises an actuating component slidably arranged on an inner surface of the housing and capable of triggering a key switch when sliding relative to the inner surface; the housing comprising:
a first positioning component arranged in the housing; and
a second positioning component arranged on the inner surface and spaced apart from the first positioning component;
wherein the first and second positioning components abut opposite sides of the actuating component for preventing the actuating component from shimmying when the actuating component sliding relative to the inner surface.

12. The housing as claimed in claim 11, wherein the key mechanism comprises an operating component, the housing defines a mounting hole; the operating component is slidably received in the mounting hole for driving the actuating component to slide relative to the inner surface.

13. The housing as claimed in claim 12, wherein the operating component comprises an operating portion and two latching portions; the operating portion is exposed out of the housing, the two latching portions extend through the mounting hole and couple to the actuating component.

14. The housing as claimed in claim 13, wherein the two latching portions comprise two hook portions, the actuating component defines two through holes; the two hook portions are respectively hooked to the through holes in a reverse direction for preventing the operating component from detaching from the actuating component.

15. The housing as claimed in claim 14, wherein the operating component comprises a fixing portion, the fixing portion comprises a fixing plate and a fixing post, the actuating component defines a fixing hole; the fixing plate is arranged between the two latching portions, the fixing post is received in the fixing hole.

16. The housing as claimed in claim 15, wherein the size of the fixing post is smaller than the fixing plate, the actuating component resists between the two hook portions and the fixing plate for securing the actuating component to the operating component.

17. The housing as claimed in claim 11, wherein the housing comprises a bottom wall and a first sidewall extending from a rim of the bottom wall; the actuating component comprises a first rim and a second rim opposite to the first rim; the first positioning component extends from the bottom wall and abuts the second rim, the second positioning component protrudes from the first sidewall and abuts the first rim.

18. The housing as claimed in claim 11, wherein the second positioning component comprises a supporting portion, a resisting portion, and a guiding portion connected between the supporting portion and the resisting portion; the first rim is received between the supporting portion and the resisting portion.

19. The housing as claimed in claim 18, wherein the actuating component defines a sliding slot, the guiding portions is slidably received in the sliding slot.

20. The housing as claimed in claim 11, wherein the actuating component comprises a driving portion, the driving portion defines a latching slot for engaging with the key switch.
